(19) United States
(12) Patent Application Publication
(10) Pub. No.: US 2004/0182225 A1
(43) Pub. Date: Sep. 23, 2004

(54) Portable custom media server

(76) Inventors: Steven Ellis, Tivoli, NY (US); Steven Askew, Germantown, NY (US)

Correspondence Address: PATENT DEPARTMENT, SKADDEN, ARPS, SLATE, MEAGHER & FLOM LLP, FOUR TIMES SQUARE, NEW YORK, NY, 10036, US

(21) Appl. No.: 10/295,201

(22) Filed: Nov. 15, 2002

(51) Int. Cl. H02G 3/00; G09B 15/02

(52) U.S. Cl. 84/476

(57) ABSTRACT

A portable storage media is configured to deliver audio content to a consumer of audio content by custom configuring the audio content on the portable storage media as well as including an interface adapted to facilitate efficient search and retrieval of the content in accordance with the custom storage attributes. The search interface is provided as part of the portable storage media to serve as a front end interface for identification and retrieval of desired content, stored on the portable media. The provision of customized content in association with a corresponding search interface enhances the operational efficiency of a production platform during the content editing and creation stages.

### FIELD OF THE INVENTION

The present invention relates to data delivery systems, and more particularly, the invention relates to musical content delivery systems.

### BACKGROUND

Musical content is incorporated into audio and video programs, which are provided to the public, as TV programs, Promotional spots, films, advertisements, live events, and radio programs. The musical content is usually added to the primary content to enhance the primary content by creating an effect or a mood. For example, a romantic scene in a film may include soft musical content to enhance the mood and feel of the film. Recently, musical content has been added to Websites to provide a produced mood and feel to the primary content.

The musical content is usually added to the visual or audio content during a production process at a production facility. This musical content is generally referred to as “production music.” Production music is generally available from stock music houses, which carry a vast catalogue of content. The production music is usually provided to the producer as CD format music. The producer reviews the content and transfers desired tracks of the production music to a local storage media, which is used by the production facility.

Often times, the transfer of tracks requires conversion to a usable format. The manual review and content transfer process can be time consuming and frustrating. Presently, there is no efficient and convenient method for identifying, retrieving, and employing desired production music by a producer at a production facility.

### SUMMARY

Accordingly, the present invention provides a method and apparatus for providing production music to a producer. The invention provides the producer with an instantly available collection of musical content stored on a portable storage media. The producer can easily locate and preview desirable content from a portable storage media, which is coupled to the production equipment.

In one embodiment, the invention facilitates a method for providing production-ready media for use by a production facility. The method stores a plurality of media items on a portable data storage device in a format specific to the production platform employed by the production facility. The method associates each media item with a plurality of information tags. The method associates each media item with search information. Finally, the method associates each media item with a unique identifier.

In another embodiment, the invention provides a musical content delivery system, which includes a portable storage media adapted to store digital data. The portable storage media includes an interface for communicating with a host computer system. A plurality of musical content files are stored in the portable storage media. A plurality of information files are stored on the portable storage media. Each information file is associated with an information category and each information file stores at least one attribute for each musical content file in the system. The attribute are selected from predetermined attributes associated with the information category. Finally, a search and retrieval interface program is stored on the portable media. The search and retrieval interface program is adapted to employ attributes from said information files to retrieve files in accordance with queries provided to the program.

### BRIEF DESCRIPTION OF THE DRAWINGS

FIG. 1 illustrates a processing flow for facilitating the provision of a collection of musical content in accordance with the invention;

FIG. 2 illustrates an arrangement of components employed in a production process employing a musical content delivery apparatus of the invention; and

FIG. 3 illustrates the logical arrangement of components in the musical content delivery apparatus from FIG. 2.

### DETAILED DESCRIPTION

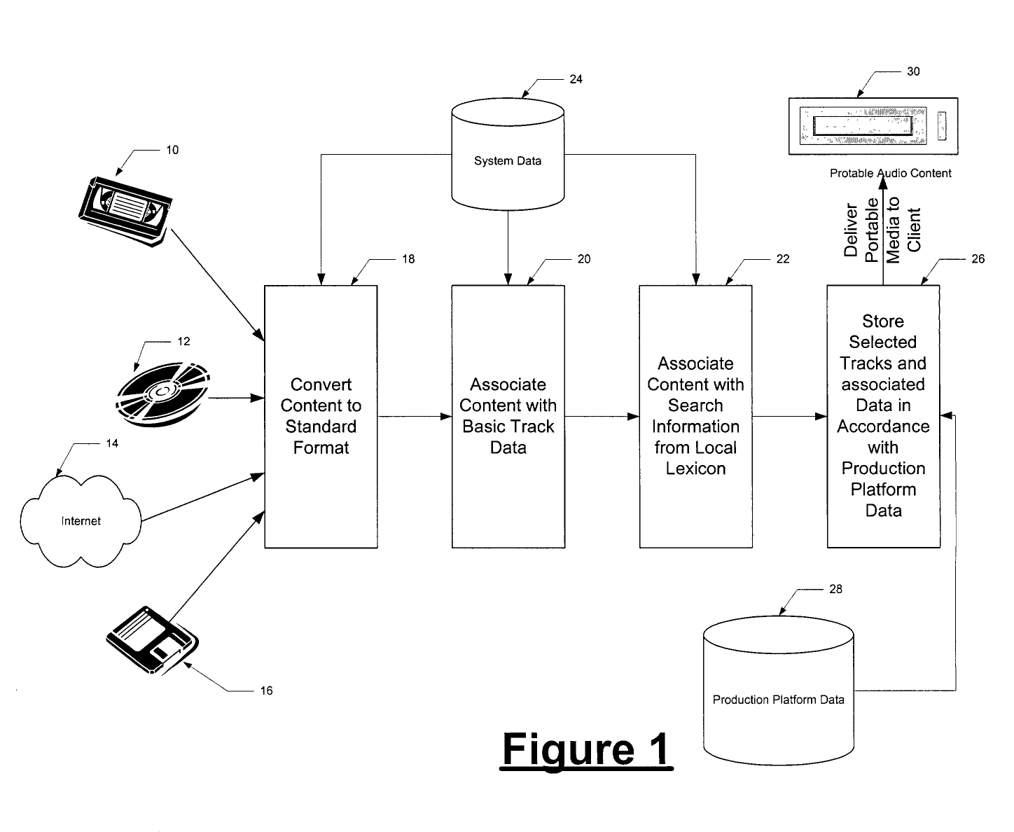

FIG. 1 illustrates the operation of a processing system for providing a portable production media in accordance with an embodiment of the invention. Musical content is generally received from various sources and in various formats. For example, content is received from audio tapes 10, CDs 12, and floppy discs 16. Content may also be received over a communication link such as the Internet 14. The system initially converts all content to a uniform format which is most convenient for manipulation by the processing system (step 18). In one embodiment, this uniform format is an OMFI format, which is employed by AVID audio processing platforms and software. As may be appreciated, in other embodiments, the content format may be a non-OMFI format as may be applicable to the processing platform employed to process the received content.

Upon receiving the content, an agent associated with a system of the invention employs the system to ensure that each track is associated with standard information tags such as length, name, artist, etc. (step 20). In another embodiment, the agent listens to each received track to determine whether the track is of minimum fidelity quality. In this embodiment, if a track is not of at least the minimum fidelity quality, the track is removed from the system and placed in a queue of tracks, which require further processing. The system preferably automatically assigns a unique identifier to each track so as to globally identify the track as between all tracks in the system. This identifier allows for the search engine to store search information for the track in a database table 24. The system proceeds to associate search information with each track (step 22). The search information is selected by the agent from a lexicon of terms identifying musical traits that are informative to producers. The lexicon is preferably constructed with input and effective terms, which are received from producers or other potential recipients of the musical content. Example lexicon term categories include genre, mood, and tempo, featured instrument, vocal type, lyrical content.

Select tracks are then stored on a portable storage media 30, along with the corresponding basic track data and search information (step 26). In one embodiment, the portable storage 30 is a hard-disk drive that complies with either the Firewire, USB or SCSI standard, depending on the production facility's requirements.

As is illustrated by FIG. 1, the system references production platform information 28 associated with the production facility for which the content is prepared. In one embodiment, the production platform information includes platform identifier, file formats, preferred tag information, media interface, and bit rate. Accordingly, the production-ready content stored on the portable storage media 30 is stored such that it is in the most efficient and convenient form for retrieve and use by the particular production facility.

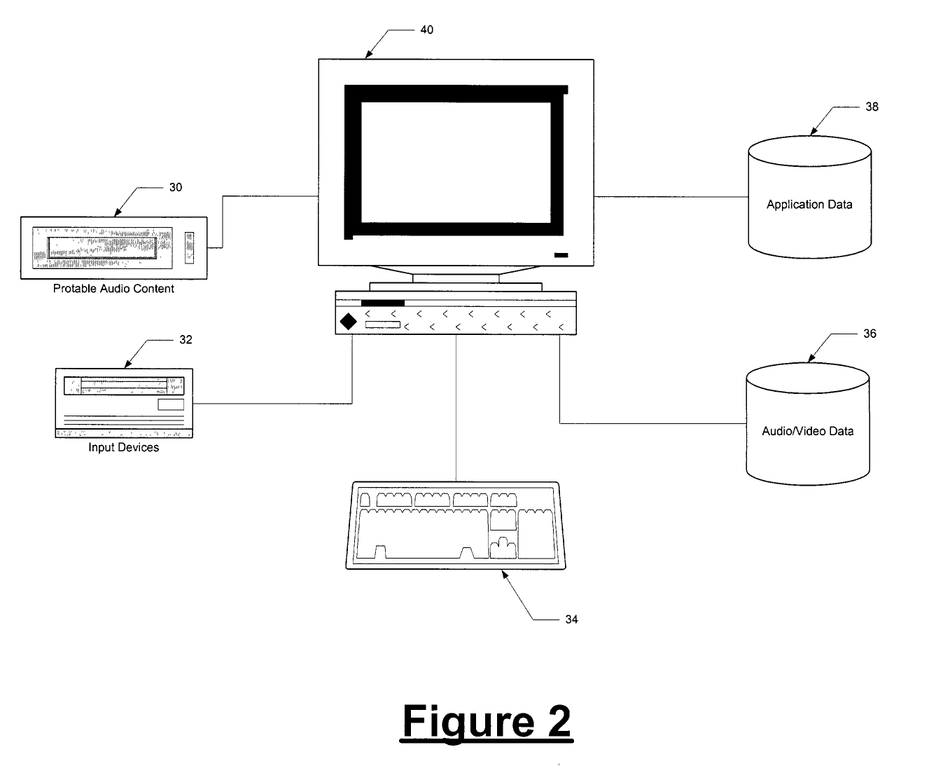

FIG. 2 illustrates some of the components associated with a production facility employing the portable storage media provided in accordance with the invention. The facility includes a production board 40. The production board 40 preferably includes components for editing audio and video to provide a produced look and feel. The production board is associated with video storage 36. The video storage is used to store video content, prior to, and after, processing by the production facility. Data storage 38 is also associated with the production board to store application programs, which are used in the video or audio editing process. In one embodiment, the production board includes a processor adapted to execute program code. Input devices 32 are associated with the production board. Examples of input devices 32 include CD-Rom, floppy drives, video camera, hard drives for video data storage, tape machines. The production board also includes output devices such as speakers and a video screen. A control panel 34, such as a keyboard, is preferably associated with the production board 40.

The music content is provided on the portable media 30 with corresponding search information and in an appropriate format for the production facility, as discussed with reference to FIG. 1. Accordingly, the content is formatted for immediate use by the production board 40 without the required conversion of prior systems. The production board 40 executes a search-engine and browsing front-end program, associated with the provided media 30, to search and retrieve desired content by reference to search information associated the content. For example, a producer can employ the search engine to request a fast, dramatic track, containing string instruments. In one embodiment, producers can initiate a search based on any combination of genre, mood, tempo, and featured instrument.

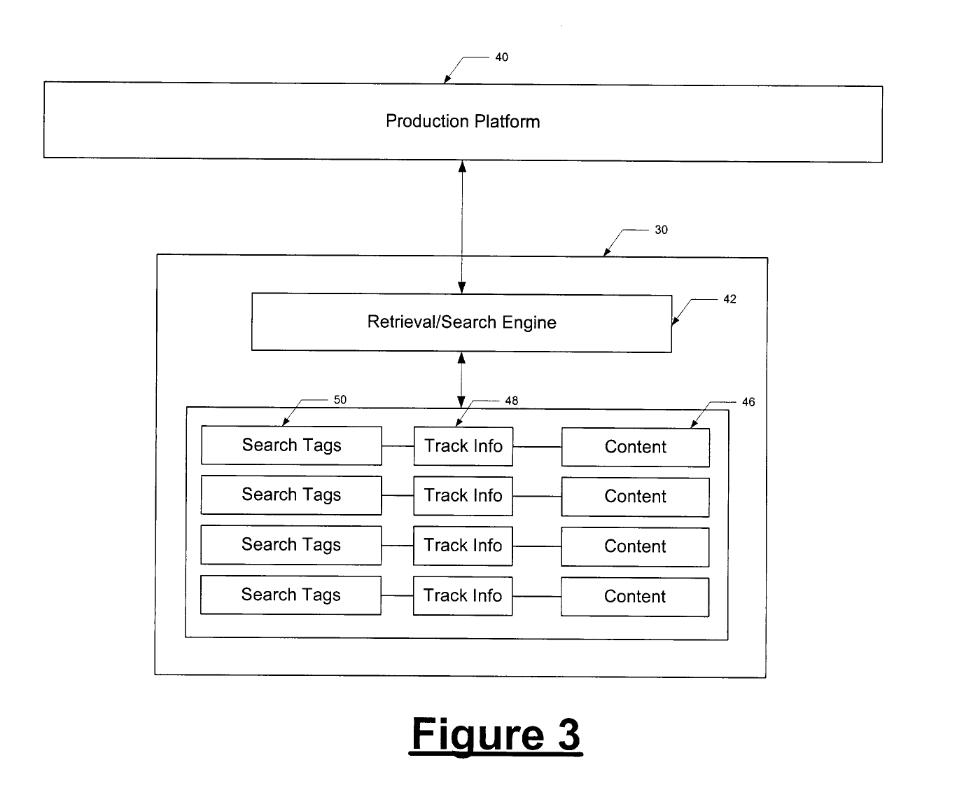

FIG. 3 illustrates logical components and data associated with the portable storage media 30 of FIG. 2. Each unit of musical content 46, or track, is associated with two groups of data. First, standard track data 48 is associated with the track such as length, title, and media identification number. Second, detailed content identifiers from the identification lexicon 50 are associated with the track for searching. A search engine program 42 is executed for searching and retrieving content. The search engine serves as an interface for the production platform 40 to employ the content in the production process. In one embodiment, the search engine 42 is included on the portable storage media. In another embodiment, the search engine 42 is part of the production platform.

In one embodiment, specifically employed when the portable media is used by the AVID software, when the user initiates the search engine interface 42, the screen presents several bins, each including tracks associated with a particular music type, or genre. The bins are preferably folders within the AVID project window on the user's screen, with each track stored according to a corresponding genre. The streamlined presentation allows a producer to instantly preview and select audio tracks, without wasting time changing physical CDs and importing tracks into the production platform. Information regarding song title, mood, tempo, and speed as well as the relevant cue sheet information for each track including names of writers, publishers and performing rights affiliations is preferably included with each track. This cue sheet information can be easily exported to or integrated with tracking applications and databases for identifying songs used in the produced material. As is known, cue sheet information is necessary for the ultimate broadcaster or performer to comply with the requirements of the performing rights societies (e.g., ASCAP, BMI). From the perspective of the producer, the entire process is self contained and instantly accessible. Furthermore, new tracks can be added to those contained in a particular portable media with ease. The portable media can be easily unplugged, tucked in an attaché case, and taken to another production platform.

With respect to audio production, the portable media 30 can store tracks in either Wave or AIFF format for use with a proprietary video/audio platform, such as Fairlight or AVID. The portable media 30 is also adapted to be easily used in connection with ProTools, the prevalent audio editing system in the music recording industry. Once a track is identified in responses to the search, the client can preview the selection by replaying the track directly from the portable media 30. With one click, the producer can copy the track to a local drive. The producer can also add the track to a “favorites list” so as to have the track available for future use. In this manner, tracks may be collected in a single folder for use at a later date. When the time comes to begin work on a future production, the producer exports the entire contents of any folder to a desired destination on a local network to allow for use at the applicable production platform. In this manner, a music supervisor or producer can search and mark tracks for multiple productions and later retrieve the tracks when needed. The producer is able to easily forward the tracks to destination production platforms on the network in accordance with the previous selection operation.

Although the present invention was discussed in terms of certain preferred embodiments, the invention is not limited to such embodiments. A person of ordinary skill in the art will appreciate that numerous variations and combinations of the features set forth above can be utilized without departing from the present invention as set forth in the claims. Thus, the scope of the invention should not be limited by the preceding description but should be ascertained by reference to claims that follow.

1. A method for providing production-ready media for use by a production facility, comprising:
storing a plurality of media items on a portable data storage device in a format specific to the production platform employed by the production facility;
associating each media item with a plurality of information tags;
associating each media item with search information; and
associating each media item with a unique identifier.

2. The method of claim 1, further comprising storing a search engine front-end program on the portable data storage device, the search engine front-end program adapted to employ the search information to provide search results.

3. The method of claim 2, wherein the search engine allows a user to search for media items in accordance with search information categories.

4. The method of claim 2, wherein the search engine facilitates adding a media item to a collection list corresponding to a specific user.

5. A musical content delivery system, comprising:
a portable storage media adapted to store digital data, the portable storage media including an interface for communicating with a host computer system;
a plurality of musical content files stored in the portable storage media;
a plurality of information files stored on the portable storage media, each information file associated with an information category, each information file storing at least one attribute for each musical content file system, the attribute selected from predetermined attributes associated with the information category; and
a search and retrieval interface program stored on the portable media, the search and retrieval interface program adapted to employ attributes from said information files to retrieve files in accordance with queries provided to the program.

6. The system of claim 5, wherein the storage media is a SCSI interface disk drive.

7. The system of claim 5, wherein the storage media is a USB interface disk drive.

8. The system of claim 5, wherein the content is in AIFF format.

9. The system of claim 5, wherein the content is in WAV format.

10. The system of claim 5, wherein the content format is determined by reference to attributes of the host computer system.

11. The system of claim 5, wherein the information categories are selected from the group consisting of genre, mood, tempo, and featured instrument.

12. The system of claim 5, wherein the search and retrieval interface program is stored in an executable format.
